(19) United States
(12) Patent Application Publication
(10) Pub. No.: US 2022/0155703 A1
(43) Pub. Date: May 19, 2022

(54) DETERMINING REFLECTOR STATES IN PRINT OPERATIONS

(71) Applicant: Hewlett-Packard Development Company, L.P., Spring, TX (US)

(72) Inventors: Nathan A. Levy, Ness Ziona (IL); Ron Benari, Ness Ziona (IL); Michael Plotkin, Ness Ziona (IL); Craig Breen, Ness Ziona (IL); Ron Emanueli, Ness Ziona (IL); Haim Livne, Ness Ziona (IL); Zvi Erlich, Ness Ziona (IL)

(73) Assignee: Hewlett-Packard Development Company, L.P., Spring, TX (US)

(21) Appl. No.: 17/433,024

(22) PCT Filed: Jul. 16, 2019
(86) PCT No.: PCT/US2019/041986

§ 371 Date: Aug. 23, 2021

(51) Int. Cl. G03G 15/043; G03G 15/04

(52) U.S. Cl. CPC G03G 15/043; G03G 15/04036

(57) ABSTRACT

In an example, a method comprises: directing a sensing beam towards a reflective component of a print apparatus in a direction; detecting a reflected portion of the sensing beam at a detector comprising a two-dimensional sensing region; obtaining an indication of a location of the reflected portion of the sensing beam incident on the two-dimensional sensing region; and determining an orientation of the reflective component based on a correspondence between the location of the portion of the sensing beam on the two-dimensional sensing region and the direction of the sensing beam reflected by the component according to its orientation.

### BACKGROUND

In some print apparatus, a pattern of print agent such as toner or ink is applied to at least one surface. In some such examples, a photoconductive surface may be charged with static charge and a light source, for example a laser light source, is used to dissipate the static charge in selected portions of the photoconductive surface to leave a latent electrostatic image. The latent electrostatic image is an electrostatic charge pattern representing a pattern to be printed. An electrostatic print agent (for example, a toner, or an ink comprising electrically charged particles) may be applied to the photoconductive surface. The electrostatic print agent attracted to the latent electrostatic image on the surface and forms a pattern on the surface of the latent electrostatic image. This pattern may be formed on or transferred to (in some examples, via an intermediate transfer member (ITM)) a print substrate. Other types of print apparatus comprise three dimensional print apparatus.

### BRIEF DESCRIPTION OF DRAWINGS

Non-limiting examples will now be described with reference to the accompanying drawings, in which:

FIG. 1 is a flowchart of an example method of determining a reflector state in a print apparatus;

FIG. 2 is a schematic drawing of an apparatus for determining a reflector state in a print apparatus;

FIG. 3 is a schematic drawing of part of a print apparatus;

FIG. 4 is a schematic drawing of a print apparatus sensor;

FIG. 5 is another flowchart of an example method of determining a state of a reflector in a print apparatus; and

FIG. 6 is a schematic drawing of a print apparatus.

### DETAILED DESCRIPTION

In a print apparatus such as an electro photographic print apparatus as described in more detail below, a light source such as a scanning laser beam may be reflected by a reflector towards a photoconductor such as a photo imaging plate, PIP, which may be configured on a drum, belt or other photoconductor transport apparatus. The position of incidence (i.e., scanning laser beam spot placement) of the scanning laser beam on a photoconductor can be subject to errors due to irregular movement of the photoconductor as it moves or rotates. Accordingly, the orientation of the reflector can be controlled by actuators to improve accuracy of the spot placement. For example, the reflector may be rotated by the actuators about an axis parallel to the axis of rotation of the photoconductor so that, in an example where the photoconductor has a circular cross-section such as where configured on a drum, rotation of the reflector may cause a corresponding change in the spot placement circumferentially around the photoconductor (i.e., in a direction that is parallel to the movement direction of the photoconductor at the position of incidence). Other types of print apparatus such may comprise a reflector or other similar component which controls the position of incidence of light such as a scanning light beam in the print apparatus. For example, in a three-dimensional print apparatus, directed energy may be used in some three-dimensional print apparatus (or additive manufacturing apparatus), such as in selective laser sintering.

As print apparatus increases in size, the length of the reflector may also increase. For example, reflectors of lengths greater than around 50 cm, or around 70 cm may be suitable. Reflectors of such lengths can be subject to bending when being rotated, which may cause inaccuracies in terms of spot placement. While rotation of the reflector by the actuators may correct for inaccuracies in terms of spot placement circumferentially around the photoconductor, the bending of the reflector may cause inaccuracies in terms of spot placement longitudinally along the length of the photoconductor. A strategy for reducing the error in the longitudinal spot placement may be to provide supports for the reflector (e.g., in the form of rolling bearing devices) along the length of the reflector to reduce the effects of the bending. However, this may increase the complexity of the mechanical components in the print apparatus.

As used herein, “electro photographic” printing generally refers to the process that provides an image that is transferred from a photo imaging substrate either directly or indirectly via an intermediate transfer member. As such, the image is not substantially absorbed into the photo imaging substrate on which it is applied. Additionally, “electro photographic print apparatus” generally refer to those print apparatus capable of performing electro photographic printing, as described above. “Liquid electro photographic printing” is a specific type of electro photographic printing where a liquid ink is employed in the electro photographic process rather than a powder toner such as used in “dry electro photographic printing”.

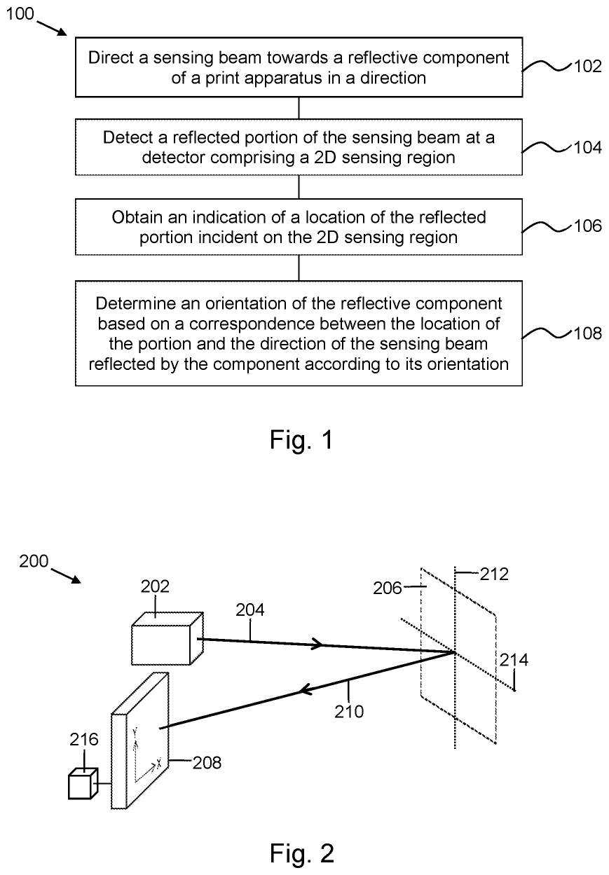

FIG. 1 is a flowchart of an example method 100, which may be, at least in part, a computer-implemented method, for characterizing the degree of rotation and/or bending state of a reflector such as may be used in a print apparatus such as an electro photographic print apparatus or a three-dimensional print apparatus.

In block 102, the method 100 comprises directing a sensing beam towards a reflective component of a print apparatus in a direction. In some examples, the sensing beam may comprise a laser beam. In some examples described herein, a ‘reflective component’ may instead be referred to as a ‘reflective element’ or ‘reflective portion’.

As will be explained in greater detail below, the sensing module may direct the sensing beam in a direction towards the reflective component. The reflective component may be integral to, coupled to or otherwise associated with—or indeed may comprise the reflector described above such that any movement of the reflector (e.g., rotation or bending) may result in a change in direction of a portion of the sensing beam reflected away from the reflective component.

In block 104, the method 100 comprises detecting the reflected portion of the sensing beam at a detector comprising a two-dimensional sensing region. The detector may comprise a two-dimensional position sensitive detector, PSD. In some examples, the detector may sense the position of the reflected portion incident on its two-dimensional sensing region and generate a signal indicative of a co-ordinate (e.g., an X and Y co-ordinate) of the position of incidence of the reflected portion on the sensing region.

In block 106, the method 100 comprises obtaining an indication of a location of the reflected portion of the sensing beam incident on the two-dimensional sensing region. For example, processing circuitry may be used for obtaining the indication of the location of the reflected portion, for example, by obtaining the signal indicative of the co-ordinate of the position of incidence of the reflected portion on the sensing region.

In block 108, the method 100 comprises determining an orientation of the reflective component based on a correspondence between the location of the portion of the sensing beam on the two-dimensional sensing region and the direction of the sensing beam reflected by the component according to its orientation. The direction of the reflected portion may depend on the orientation of the reflected component. Since the location of the reflected portion on the sensing region corresponds to a specified direction of the reflected portion, it is then possible to determine the orientation of the reflective component.

The orientation of the component may be indicative of a rotational angle and a bending state of the reflective component, where the reflective component is for directing a scanning laser beam towards a target, which may comprise a photoconductive plate (which is an example of a photoconductor such as a PIP) of the print apparatus, or a print bed of a three dimensional printing apparatus. In other examples, orientation of the component may be indicative of a rotational angle and a bending state of a reflector on which the reflective component is mounted.

For example, where a force is applied to the reflector to effectuate rotation of the component which directs a scanning beam towards a PIP (the reflector may comprise or represent the reflective component) (i.e., to control circumferential positioning of the scanning laser beam spot placement on the PIP), this may cause a corresponding change in the direction of the reflected portion of the sensing beam to be registered by the detector. For example, rotation of the reflector may cause the detector to register a change in the position of incidence of the reflected portion of the sensing beam in one of its two dimensions (e.g., a change in the detected “X co-ordinate”). Similarly, bending of the reflector may cause the detector to register a change in the position of incidence of the reflected portion of the sensing beam in the other of its two dimensions (e.g., a change in the detected “Y co-ordinate”). Thus, depending on the X and Y co-ordinate of the reflected portion of the sensing beam, a determination may be made to verify that the reflector is in the correct position for accurate spot placement and/or the actuators may be caused to correct for any inaccuracies in terms of spot placement. Such actuators may be the same as or different to the actuators used for rotating the reflector. The actuators may operate individually or collectively to apply a force to the reflector to effectuate one or both of rotation and bending (or bending correction) of the reflector.

In other words, the method of FIG. 1 may be used to characterize the degree of rotation and/or bend state of the reflector to enable actuators to apply an appropriate force to the reflector to correct for any inaccuracies in terms of spot placement. This may for example mean that fewer supports may be used in the apparatus, simplifying its structure.

FIG. 2 is a simplified schematic representation of a print apparatus sensor 200, which may be used to implement at least some of the blocks of method 100. The print apparatus sensor 200 comprises a sensing beam source 202 which may be a directional light source such as a laser or another suitably focused and/or collimated light source to produce a sensing beam 204 for reflection by a reflective element 206 of a component of a print apparatus. As referred to previously, the reflective element 206 may be integral to, coupled to or otherwise associated with the reflector (which is an example of a ‘component’ of a print apparatus) described above such that any movement of the reflector (e.g., rotation or bending) may result in a change in direction of a portion of the beam 204 reflected away from the reflective element 206. The reflective element 206 is depicted by dashed lines in FIG. 2 to indicate that the reflective element 206 may, in some examples, not form part of the print apparatus sensor 200.

The print apparatus sensor 200 further comprises a detector 208 to detect a location of a portion 210 of the beam reflected by the reflective element 206 in two axes. These two axes are depicted in dotted lines in FIG. 2 as being two orthogonal axes 212, 214. Movement of the reflective element 206 about one or both of these axes 212, 214 causes a corresponding change in direction of the reflected portion 210. For example, rotation about axis 212 causes a change in the X co-ordinate of the position of incidence of the reflected portion 210 on the detector 208. Similarly, rotation about axis 214 causes a change in the Y co-ordinate of the position of incidence of the reflected portion 210 on the detector 208. The X and Y axes are depicted on the surface (e.g., a sensing region) of the detector 208. It may be noted that while the axes 214 and 212 are shown as passing through the center of the reflective element 206 in this example, this may not be the case in all examples. For example, if the element 206 comprises a reflective ‘target’ mounted towards one end of a reflector which is subject to flexing, then the rotation of the reflective element due to such flexing may be rotation about an axis which is offset from the reflective element 206.

In some examples, the detector 208 may comprise a two-dimensional, 2D, position sensitive detector, PSD, which may comprise a 2D sensing region. The sensing region may have dimensions suitable for detecting the angular range of directions of the reflected portion 210. The particular optical arrangement between the sensing beam source 202 and the detector 208 may affect the angular range of directions of the reflected portion. Accordingly, the sensing region may have dimensions appropriately selected to detect the specified angular range of directions. In some examples, the sensing region may have dimensions selected according to a specified range of positions of incidence on the sensing region (e.g., which can be calculated by the particular optical configuration).

For example, if the specified range of positions is ±0.8 mm from the center of the sensing region, then the sensing region may have dimensions equal to or greater than 1.6×1.6 mm. Some examples of 2D PSDs may comprise a plurality of electrical contacts located to measure current flow through specified regions of the 2D PSD. This current flow is affected by the location of the sensing beam on the 2D PSD. By measuring and comparing the electrical current through these regions, it is possible to determine the location of the sensing beam. Other 2D sensors, or an array of 1D and/or point sensors may be used in other examples.

The print apparatus sensor 200 further comprises processing circuitry 216 to determine an indication of the rotation of the reflective element 206 (and thereby an orientation and flex of the reflective element 206, or a reflector on which it is mounted) based on the detected location. The processing circuitry 216 is depicted in FIG. 2 as being communicatively coupled to the detector 208. The processing circuitry 216 could be integral to or a separate component of the detector 208. The processing circuitry 216 may obtain an indication of the location of the reflected portion 210 on the detector 208. This indication may be compared with predetermined information regarding a correspondence between the location of the reflected portion 210 and the orientation of the reflective element 206 in two axes. The predetermined information may comprise a table of data and/or calibration information stored on a tangible machine-readable medium (not shown) communicatively coupled to the processing circuitry 216. In some examples, the predetermined information may be generated using measurements of the detected location (e.g., X-Y co-ordinates) of the reflected portion 210 for a plurality of orientation states of the reflective element 206. In use, upon obtaining the indication of the detected location of the reflected portion 210, the processing circuitry 216 may determine the orientation and flex state of the reflective element 206, or a reflector on which it is mounted based on the predetermined information.

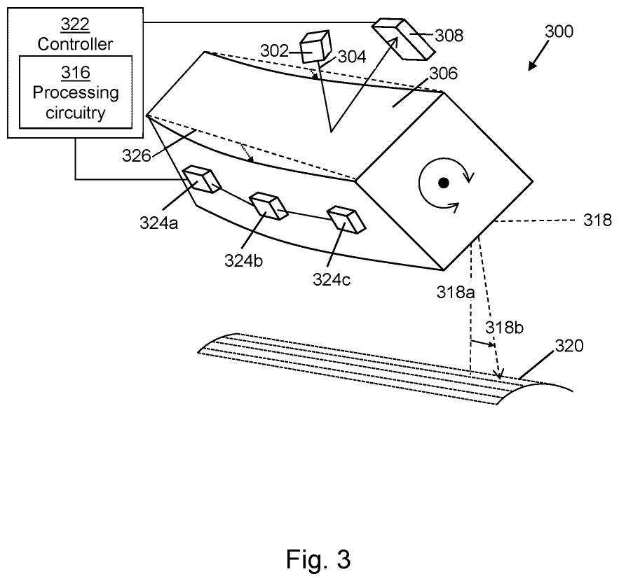

FIG. 3 depicts a simplified schematic representation of part of a print apparatus 300 comprising the print apparatus sensor 200 of FIG. 2. Corresponding features of the print apparatus sensor 200 are represented by reference numerals incremented by 100 and certain features and reference numerals have been omitted for brevity.

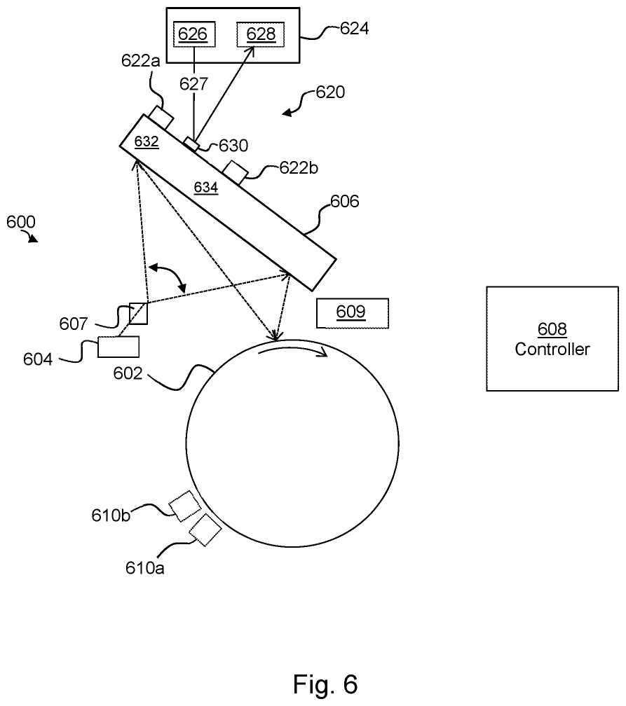

In the depicted example, the reflective component 306 has an elongate reflector body (in this example, the reflective component is an example of a “reflector” as described above) of the print apparatus 300. However, as referenced previously, in other examples, the reflective component 306 could be integral to, coupled to (e.g., in the form of a separate mirror attached to the elongate reflector body) or otherwise associated with the elongate reflector body. In use, the reflective component directs a scanning laser beam 318 towards a photoconductive plate 320 (e.g., a PIP) of the print apparatus 300. Although not visible in the figure, the reflective component 306 comprises a reflective surface for reflecting the scanning laser beam 318 as depicted by the arrow. The role of the scanning laser beam 318, which is used to ‘write’ a latent image on the photoconductive plate 320, is discussed in greater detail below with reference to FIG. 6. However, the scanning laser beam 318 is distinct from the beam 304 produced by the sensing beam source 302 that is reflected by the reflective component 306 towards the detector 308.

In some examples, the print apparatus 300 may further comprise a controller 322. The controller 322 may comprise or be communicatively coupled to the processing circuitry 316 for determining an indication of an orientation and flex of the reflective component 306 based on the detected location. In use, the controller 322 generates a control signal for controlling an actuator 324 associated with the reflective component 306, for example, based on the indication of the orientation and flex of the reflective component 306. In the depicted example there are three actuators 324a,b,c (which may also be referred to as ‘actuator elements’) disposed along the length (on one side) of the elongate reflector body. Although not visible in FIG. 3, there may be further actuators disposed along the length, but e.g., on another side, of the reflective component 306. These actuators may apply appropriate forces at the various locations on the reflective component 306. In some examples, an actuator on one side of the reflective component 306 may apply a force at the same time as an actuator on another side of the reflective component 306 to effectuate rotation and/or bending control thereof. In some examples, there may be a different number of actuators such as one actuator, two actuators or more than two actuators. At least part of the actuators 324a,b,c may be mechanically connected to a support (not shown) to enable a force to be applied by the actuator 324 on the reflective component 306 relative to that support. The actuators 324a,b,c could take various forms and comprise appropriate elements to generate a force on the reflective body based on the control signal (e.g., the force may be generated by mechanical, electrical and/or magnetic elements, and so on).

The actuators 324a,b,c may be communicatively coupled to the controller 322 in order to receive the control signal. The control signal may control the actuators 324a,b,c such that the orientation and flex of the reflective component 306 tends towards an intended state. For example, if there is an error in the circumferential positioning of the scanning laser beam 318 on the photoconductive plate 320, at least one of the actuators 324a,b,c may apply an appropriate force on the reflective component 306 to cause rotation thereof in an appropriate manner. Similarly, if there is an error in the longitudinal positioning of the scanning laser beam 318 on the photoconductive plate 320, at least one of the actuators 324a,b,c may apply an appropriate force on the reflective component 306 to reduce the effect of the bending of the reflective component 306. The actuators 324a,b,c may apply a force on the reflective component 306 independently of each other to control movement of the reflective component 306. In some examples, two or more actuators 324a,b,c may apply a force independently of each other in the same direction to cause rotation of the reflective component 306. In some examples, two or more actuators 324a,b,c may apply a force in different directions to reduce the effect of bending of the reflective component 306.

In FIG. 3, the reflective component 306 is depicted as experiencing bending, in that it is displaced from a straight ‘rest’ position shown by dotted line 326. In this example, the reflective component 306 is bending ‘toward’ the photoconductive plate 320. In other words, the ‘reflecting face’ of the reflective component 306 for reflecting the scanning laser beam 318 is depicted as bending toward the photoconductive plate 320 (e.g., the ‘reflecting face’ may comprise a convex surface). This is also apparent from the depicted angular displacement of the scanning laser beam 318 on the photoconductive plate 320. If the reflective component 306 is in its straight ‘rest’ position (i.e., its ‘intended state’), the scanning laser beam 318 would ideally be reflected in a direction along the dotted line 318a. However, the type of bending experienced by the reflective component 306 in this example is such that the scanning laser beam 318 is incorrectly reflected in a direction along the dotted line 318b. Thus, in this example, there is an error in the spot placement longitudinally along the photoconductive plate 320. In other examples, different types of bending may be experienced by the photoconductive plate 320.

A possible way to correct for this bending may be for at least one of the actuators 324 to apply a force on the reflective component 306. The manner by which the actuators 324 may correct for inaccuracies in terms of spot placement may depend on the particular rotation and/or bending experienced, as well as the types of actuators 324 provided.

Based on the particular type of bending depicted in FIG. 3, at least one of the actuators 324 (and potentially other actuator(s) mounted on the opposite face of the reflective component 306 that are not visible in the drawing) could apply a force on the reflective component 306 in a direction ‘away’ from the photoconductive plate 320 to restore the reflective component 306 to its intended shape as depicted by the dotted line 326. For example, this could be achieved by the actuator 324b applying a force on the reflective component 306 in a direction that is parallel to the reflective component face to which the actuators 324a,b,c are mounted (and away from the photoconductive plate 320).

In other similar words, the force applied the actuator 324b could be in a direction perpendicular to the reflective component surface that reflects the scanning laser beam 318 (i.e., the ‘reflecting face’). In this manner, the bending could be reduced in order to restore the reflective component 306 towards its ‘intended state’ depicted by the dotted line 326.

At certain locations along the length of the elongate reflector body, bending may cause a change in the orientation of the reflective component 306 as can be registered by the beam 304. For example, if the axis of bending is approximately in the center of the elongate reflective component 306, the largest change in orientation angle may be seen towards the ends of the body of the reflective component 306 (whereas the orientation of center may be little affected by such flexing. However, the position of the largest change may depend on factors such as mounting arrangements. Accordingly, the position of incidence of the beam 304 on the reflective component 306 may be selected according to where bending may cause the largest changes in orientation that occur along the length of the reflective component 306 (for example, being off-center, and in some examples, relatively near the end portions in some examples).

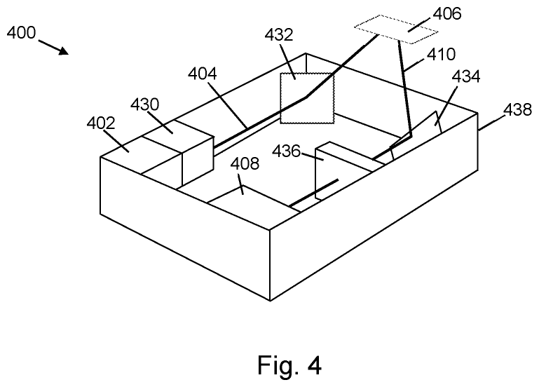

FIG. 4 is a simplified schematic representation of a print apparatus sensor 400, which may comprise similar features to the print apparatus sensor 200 of FIG. 2. Corresponding features of the print apparatus sensor 400 are therefore represented by reference numerals incremented by 200.

The print apparatus sensor 400 comprises a sensing beam source 402 to produce a sensing beam 404. In some examples and as depicted, the print apparatus sensor 400 further comprises an optical device such as a collimator 430 to collimate the sensing beam 404 produced by the sensing beam source 402. The collimated beam 404 is directed towards a first beam redirector, which in this example is in the form of a first folding mirror 432 angled to direct the collimated beam 404 towards the reflective component 406. The portion 410 of the beam 404 reflected by the reflective component 406 is directed towards a second beam redirector, which in this example is in the form of a second folding mirror 434. The second folding mirror 434 is angled to direct the reflected portion 410 towards a beam manipulation element such as a focusing lens 436 to focus the reflection portion 410 on the detector 408.

At least one of the collimator 430, first and second folding mirrors 432,434 and the focusing lens 436 may define an optical assembly for directing the sensing beam 404 between the sensing beam source 402 and the detector 408 via the reflective element 406. The folding mirrors 432, 434 may allow for the assembly to be compact, and/or have a suitable form factor of integration in print apparatus. In some examples, as depicted by FIG. 4, the sensing beam source 402, the detector 408 and the optical assembly are housed in a common housing 438. The common housing 438 may comprise a cover, or otherwise be fully enclosed, to protect its internal components (i.e., the sensing beam source 402, the detector 408 and the optical assembly). A cover or the like is not shown in FIG. 4 to provide a view of the internal components supported by the common housing 438. An aperture may be provided within such a cover to allow the sensing beam 404 to exit the print apparatus sensor 400 and allow the reflected portion 410 to enter the print apparatus sensor 400. The common housing 438 may provide mechanical stability to ensure proper alignment of the internal components is maintained while the print apparatus is being transported or is in use. The common housing 438 may be secured to an appropriate part of the print apparatus so that the beam may, in use, be incident on the reflective element 406 of the component (e.g., the reflector for reflecting the scanning laser beam described above).

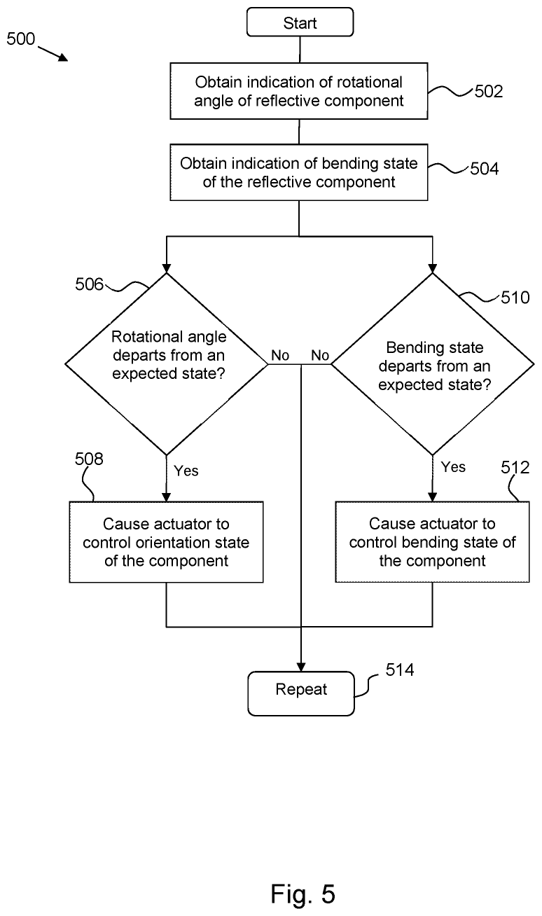

FIG. 5 is a flowchart of an example method 500, which may be a computer-implemented method, which may be implemented as part of or in conjunction with the method 100 described in relation to FIG. 1.

As explained previously, the orientation of a reflective component may be indicative of a rotational angle and a bending state of the reflective component, where the reflective component is for directing a scanning laser beam towards a photoconductive plate of the print apparatus. In other examples, the reflective component may comprise a portion of, or be mounted on, such a print apparatus component.

In this example, the method 500 comprises, in block 502, obtaining an indication of the rotational angle of the reflective component based on a determination of a detected location of the portion of the sensing beam with respect to a first axis of the sensing region.

Block 504 comprises obtaining an indication of the bending state of the reflective component based on a determination of a detected location of the portion of the sensing beam with respect to a second, axis of the sensing region, where the first and second axes are perpendicular. The first and second axes may refer to the X and Y axes depicted on the detector 208 of FIG. 2. Accordingly and still with reference to FIG. 2, rotation and/or bending of the reflective element 206 may direct the reflected portion 210 to be detected at a certain location on the detector, which may be indicative of the rotational angle and/or bending state of the reflective component 306 depicted in FIG. 3. Although

FIG. 5 depicts both of the blocks 502 and 504 being implemented before the method 500 proceeds to one of the subsequent blocks (e.g., blocks 506 or 510), in some examples, one of the blocks 502 and 504 may be skipped while the other of the blocks 502 and 504 may be implemented before proceeding to one of the subsequent blocks (e.g., blocks 506 or 510).

In this example, block 506 comprises determining whether the rotational angle of the reflective component in respect of the first axis (the ‘orientation state’) departs from an expected, or intended, state. If so, in block 508, the actuator controls the rotational angle of the reflector body towards the expected state. If not, it may be determined that the orientation state of the reflective component corresponds to the expected state such that no further action is specified in this regard.

In some examples, the orientation of the reflective component may be controlled to compensate for irregular movements in a photoconductor e.g., due to movement of a photoconductor transport apparatus such as a drum or belt. For example, the photoconductor transport apparatus may not move or rotate smoothly (for example being subject to internal friction, and external actions such as print agent applicators which may act thereon), and this can be corrected for by controlling the orientation of the reflective component- usually with small changes in angle- as the photoconductor transport apparatus moves or rotates. Information regarding the movement or rotation of the photoconductor transport apparatus may for example be provided by encoders or the like. Thus, this information may provide a feedback loop to ensure that the orientation is as intended. The expected state may refer to a specified orientation state of the reflective component that results in the scanning laser beam being incident on the photoconductive plate (i.e., spot placement) with a specified degree of accuracy (e.g., a threshold accuracy). For example, block 506 may obtain an indication of the accuracy of spot placement and compare this indication with a threshold accuracy (which may be predetermined) to determine whether or not the reflective component is in its ‘expected orientation state’. Blocks 502 to 506 may be implemented again/repeatedly to confirm whether or not the reflective component is still in the ‘expected state’ during use.

In some examples, the spot placement accuracy may be measured during production of the write head (described below) using a measuring device (e.g., external to the print apparatus) that measures a parameter of the light source e.g., the scanning laser beam angle. In some examples, spot placement accuracy may be indirectly determined with a printing job for measuring ink placement inaccuracy. For example, the print apparatus may comprise an in-line scanner for scanning a printed media generated by the printing job to allow a comparison to be made between the printed media and an expected result from the scan. This comparison may be used to determine an appropriate correction to be made by the reflective component.

In this example, the method 500 also comprises, in block 510, determining whether the bending state of the component departs from an expected state. If so, in block 512, the method 500 may comprise controlling at least two actuator elements independently to control the bending state of the reflector body towards the expected state. If not, it may be determined that the bending state of the reflective component corresponds to the expected state such that no further action is specified. The expected state may refer to a specified bending state of the reflective component that results in the scanning laser beam having a spot placement with a specified degree of accuracy (e.g., a threshold accuracy). For example, similar to block 506, block 510 may obtain an indication of the accuracy of spot placement and compare this indication with a threshold accuracy (which may be predetermined) to determine whether or not the reflective component is in its ‘expected state’.

As indicated in block 514, the method may operate repeatedly, for example substantially continuously, during a printing operation to confirm whether or not the reflective component is still in the ‘expected state’ during use.

FIG. 6 is a schematic representation of an example of a print apparatus 600 comprising a photoconductor 602, a write head 604, a moveable mirror 606 and controller 608.

The print apparatus 600 comprises the moveable mirror 606 (e.g., the ‘reflector’ or ‘reflective component’ which comprises a reflective surface to reflect the scan of light from the scanning mirror to the photoconductor), where movement of the moveable mirror 606 changes the angle at which the scan of light strikes the photoconductor during a scan thereof, allowing for the overall length of the photoconductor to be addressed in building up a latent electrostatic image to be tailored to the scaling applied to the image. For example, the moveable mirror 606 may be coupled to at least one actuator 622 (two actuator elements 622a, 622b are depicted) as described previously for controlling an angle of rotation of the moveable mirror 606 and/or a degree of bending of the moveable mirror 606. In this example, the length of the scan is provided by a scanning mirror 607 (e.g., a fast moving mirror), which moves fast relative to the other components, although in other examples other apparatus may be used. In such a way, while the center line of a scan is determined according to the placement of the moveable mirror 606, the length of the scan is provided by the scanning mirror 607 (which may for example comprise a spinning multifaceted, or polygon mirror). The length of the scan may be determined by optical system aperture(s) and/or by the dimensions of the polygon facets.

As explained previously, the reflector (or ‘moveable mirror 606’) may be used to control the accuracy of the spot placement on the photoconductor. In this regard, the scanning mirror 607 in this example controls a position of a scan of light from the write head on the photoconductor in a first axis (i.e., the first axis corresponding to the spot placement longitudinally along the photoconductor depicted by FIG. 3).

The print apparatus 600 may comprise a reflector assembly 620 to control a position of a scan of light from the write head 604 on the photoconductor 602 in a second axis (i.e., the second axis corresponding to the circumferential spot placement position around the photoconductor). In this example, the reflector assembly 620 comprises the moveable mirror 606 and the actuator 622.

The print apparatus 600 further comprises a sensing module 624 which in this example comprises an emitter 626 to produce a beam 627 (e.g., a ‘sensing beam’) for propagation towards the moveable mirror 606.

The sensing module 624 in this example further comprises a detector 628 to detect the direction of propagation of the beam 627 away from the moveable mirror 606.

As referred to previously, the direction of propagation of the beam 627 away from the moveable mirror 606 may provide an indication of the angle of rotation and the degree of bending of the moveable mirror 606.

The controller 608 may generate a control signal for controlling the actuator 622 based on the indication of the angle of rotation and/or the degree of bending of the moveable mirror 606. Accordingly, any inaccuracies in terms of spot placement may be corrected for by appropriate manipulation of the moveable mirror 606 by the actuator 622.

In some examples, and as depicted by FIG. 6, the moveable mirror 606 comprises an elongate body comprising a reflective portion 630 at one end of the elongate body for reflecting the beam 627 from the emitter 626 towards the detector 628 in a direction indicative of a relatively large bending angle of the elongate body. As discussed previously, appropriately locating the point where the beam 627 is incident on the moveable mirror 606 may allow the bending state to be readily detected by causing a corresponding change in the direction of the reflected beam 627. By being at or towards one end of the elongate body, the reflective portion 630 may be located along the length of the elongate body, i.e., between the center of the elongate body and the end of the elongate body. The location of the reflective portion 630 may be selected such that any bending in the moveable mirror 606 may be detected by the sensing module 624.

In some examples, and as depicted by FIG. 6, the moveable mirror 606 comprises an elongate body and the actuator 622 comprises two (or, in some examples, more than two) individually addressable actuator elements 622a, 622b mounted at different positions along a length of the elongate body to control the degree of bending of the moveable mirror 606. The individual actuator elements 622a, 622b may apply forces independently of each other or in unison with each other to effectuate rotation and/or bending correction of the moveable mirror 606.

As explained previously, FIG. 6 is a schematic drawing. To better illustrate the elongate form of the body of the moveable mirror 606, FIG. 6 depicts the length of the moveable mirror 606. The scanning mirror 607 scans the light from the write head 604 along the length of the moveable mirror 606, as depicted by the range indicated by the dashed lines and arrow therebetween. The moveable mirror 606 reflects the scan of light towards the photoconductor 602. As the scan of light scans along the length of the moveable mirror 606, the spot placement on the photoconductor 602 scans in a corresponding manner along the length of the photoconductor 602 (even though FIG. 6 does not explicitly show this). As explained previously, rotation of the moveable mirror 606 causes a corresponding change in the spot placement circumferentially around the photoconductor 602 whereas bending of the moveable mirror 606 may cause a corresponding change in the spot placement longitudinally along the photoconductor 602.

In some examples, and as depicted by FIG. 6, the two individually addressable actuator elements 622a, 622b are mounted in a first and second end region 632, 634 of the elongate body to control bending of the elongate body between the first and second end region 632, 634. The first and second end region 632, 634 may be defined according to where to apply forces to appropriately rotate and/or correct for bending of the moveable mirror 606.

In some examples, the direction of propagation of the beam 627 away from the moveable mirror 606 is determined based on a two-dimensional coordinate of a detected location of the beam 627 incident on the detector 628 (e.g., in a similar manner to that described in relation to FIG. 2). In some examples, the detector 628 provides the indication of: the angle of rotation of the moveable mirror 606 based on a first value of the two-dimensional coordinate (e.g., one of an X and Y value) and the degree of bending of the moveable mirror 606 based on a second value of the two-dimensional coordinate (e.g., the other one of the X and Y value).

In this example, the print apparatus 600 further comprises additional components, specifically a photo charging unit 609 and a plurality of print agent sources 610a-b. Such components may contact the photoconductor 602 and may cause disruption in the smooth rotation thereof. In other examples, different components may be provided.

In this example, the print apparatus 600 is a Liquid Electro Photographic (LEP) printing apparatus which may be used to print a print agent such as an electrostatic ink composition (or more generally, an electronic ink). The photo charging unit 609 deposits a substantially uniform static charge on the photoconductor 602, which in this example is a photo imaging plate, or ‘PIP’ and the write head 604 dissipates the static charges in selected portions of the image area on the PIP to leave a latent electrostatic image over a number of scan operations, or sweeps. The latent electrostatic image is an electrostatic charge pattern representing the pattern to be printed. The electrostatic ink composition is then transferred to the PIP from a print agent source 610a-b, which may comprise a Binary Ink Developer (BID) unit, and which may present a substantially uniform film of the print agent to the PIP. A resin component of the print agent may be electrically charged by virtue of an appropriate potential applied to the print agent in the print agent source 610. The charged resin component, by virtue of an appropriate potential on the electrostatic image areas, is attracted to the latent electrostatic image on the PIP. The print agent does not adhere to the charged, non-image areas and forms an image on the surface of the latent electrostatic image. The photoconductor 602 will thereby acquire a developed print agent electrostatic ink composition pattern on its surface, which can be transferred to a substrate or the like.

Although not illustrated, the print apparatus 600 may comprise a memory, which may store predetermined information such as described above in relation to FIG. 2. It should be noted that the parts illustrated in FIG. 6 may not have the particular orientation and/or configuration shown since the drawing is schematic.

In this example, in use of the apparatus 600, the write head 604 selectively removes charge from the photoconductor in a plurality of scans, or sweeps, thereof, each time emitting light to strike the photoconductor 602 in order to build up a latent electrostatic image.

Although the above examples are described in the context of electro photographic printing (which may comprise liquid or dry electro photographic printing techniques), methods and apparatus described herein may have utility for other printing technologies such as three-dimensional printing or for any apparatus other than print apparatus comprising a component where it may be useful to obtain information regarding the orientation of that component.

Examples in the present disclosure can be provided as methods, systems or machine-readable instructions, such as any combination of software, hardware, firmware or the like. Such machine-readable instructions may be included on a computer readable storage medium such as a tangible machine-readable medium (including but not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each block in the flow charts and/or block diagrams, as well as combinations of the blocks in the flow charts and/or block diagrams can be realized by machine-readable instructions.

The machine-readable instructions may, for example, be executed by a general purpose computer, a special purpose computer, an embedded processor or processors of other programmable data processing devices to realize the functions described in the description and diagrams. In particular, a processor or processing apparatus may execute the machine-readable instructions. Thus functional modules of the apparatus (such as the controller 322 or controller 608) may be implemented by a processor executing machine-readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine-readable instructions may also be stored in a computer readable storage that can guide the computer or other programmable data processing devices to operate in a specific mode.

Machine-readable instructions may also be loaded onto a computer or other programmable data processing devices, so that the computer or other programmable data processing devices perform a series of operations to produce computer-implemented processing, thus the instructions executed on the computer or other programmable devices realize functions specified by block(s) in the flow charts and/or in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited by the scope of the following claims and their equivalents. It should be noted that the above-mentioned examples illustrate rather than limit what is described herein, and that those skilled in the art will be able to design many alternative implementations without departing from the scope of the appended claims. Features described in relation to one example may be combined with features of another example.

The word “comprising” does not exclude the presence of elements other than those listed in a claim, “a” or “an” does not exclude a plurality, and a single processor or other unit may fulfil the functions of several units recited in the claims. Based on means based at least in part on.

The features of any dependent claim may be combined with the features of any of the independent claims or other dependent claims.

1. A method comprising:
directing a sensing beam towards a reflective component of a print apparatus in a direction;
detecting a reflected portion of the sensing beam at a detector comprising a two-dimensional sensing region;
obtaining an indication of a location of the reflected portion of the sensing beam incident on the two-dimensional sensing region; and
determining an orientation of the reflective component based on a correspondence between the location of the reflected portion of the sensing beam on the two-dimensional sensing region and the direction of the sensing beam reflected by the reflective component according to its orientation.

2. The method of claim 1, where the orientation of the component is indicative of a rotational angle and a bending state of the reflective component, where the reflective component is for directing a scanning laser beam towards a photoconductive plate of the print apparatus.

3. The method of claim 2, further comprising:
obtaining an indication of the rotational angle of the reflective component based on a determination of a detected location of the reflected portion of the sensing beam with respect to a first axis of the sensing region; and
obtaining an indication of the bending state of the reflective component based on a determination of a detected location of the reflected portion of the sensing beam with respect to a second, axis of the sensing region, where the first and second axes are perpendicular.

4. The method of claim 2, comprising:
determining whether the orientation and/or the bending state of the component departs from an expected state and, if so,
causing an actuator to control at least one of the rotational angle and the bending state of the reflective component towards the expected state.

5. The method of claim 2, comprising determining whether the bending state of the component departs from an expected state and, if so,
controlling at least two actuator elements independently to control the bending state of the reflective component towards the expected state.

6. A print apparatus sensor comprising:
a sensing beam source to produce a sensing beam for reflection by a reflective element of a component of a print apparatus; and
a detector to detect a location of a portion of the sensing beam reflected by the reflective element in two axes; and
processing circuitry to determine an indication of an orientation and flex of the component based on the detected location.

7. The print apparatus sensor of claim 6, where the reflective element is associated with an elongate reflector body of the print apparatus, where the reflector body is to direct a scanning laser beam towards a photoconductive plate of the print apparatus.

8. The print apparatus sensor of claim 6, further comprising a controller, where the controller is to generate a control signal for controlling an actuator associated with the component, where the control signal is to control the actuator such that the orientation and flex of the component tends towards an intended state.

9. The print apparatus sensor of claim 6, further comprising an optical assembly for directing the sensing beam between the sensing beam source and the detector via the reflective element, where the sensing beam source, the detector and the optical assembly are housed in a common housing.

10. A print apparatus comprising:
a photoconductor;
a write head comprising a light source to provide light to selectively remove charge from the photoconductor according to a predetermined pattern;
a scanning mirror to control a position of a scan of light from the write head on the photoconductor in a first axis;
a reflector assembly to control a position of a scan of light from the write head on the photoconductor in a second axis, the reflector assembly comprising:
a reflector comprising a reflective surface to reflect the scan of light from the scanning mirror to the photoconductor; and
an actuator to control an angle of rotation of the reflector and a degree of bending of the reflector; and
a sensing module comprising:
an emitter to produce a beam for propagation towards the reflector;
a detector to detect a direction of propagation of the beam away from the reflector, to provide an indication of the angle of rotation and the degree of bending of the reflector; and
a controller to generate a control signal for controlling the actuator based on the indication of the angle of rotation and the degree of bending of the reflector.

11. The print apparatus of claim 10, where the reflector comprises an elongate body comprising a reflective portion at one end of the elongate body for reflecting the beam from the emitter towards the detector in a direction indicative of a maximum bending angle of the elongate body.

12. The print apparatus of claim 10, where the reflector comprises an elongate body and the actuator comprises two individually addressable actuator elements mounted at different positions along a length of the elongate body to control the degree of bending of the reflector.

13. The print apparatus of claim 12, where the two individually addressable actuator elements are mounted in a first and second end region of the elongate body to control bending of the elongate body between the first and second end region.

14. The print apparatus of claim 10, where the direction of propagation of the beam away from the reflector is determined based on a two-dimensional coordinate of a detected location of the beam incident on the detector.

15. The print apparatus of claim 14, where the detector is to provide the indication of the angle of rotation of the reflector based on a first value of the two-dimensional coordinate and the degree of bending of the body based on a second value of the two-dimensional coordinate.
